(19) United States
(12) Patent Application Publication
(10) Pub. No.: US 2013/0198303 A1
(43) Pub. Date: Aug. 1, 2013

(54) AUTOMATED USER-INITIATED INVITATION SYSTEM AND METHOD

(71) Applicant: SMS.ac, Inc., San Diego, CA (US)

(72) Inventor: Michael Pousti, San Diego, CA (US)

(73) Assignee: SMS.AC, INC., San Diego, CA (US)

(21) Appl. No.: 13/747,349

(22) Filed: Jan. 22, 2013

Related U.S. Application Data
(63) Continuation of application No. 13/444,795, filed on Apr. 11, 2012, now abandoned.
Application No. 13/444,795 is a continuation of application No. 11/329,524, filed on Jan. 10, 2006, now abandoned.
(60) Provisional application No. 60/643,372, filed on Jan. 11, 2005.

(51) Int. Cl. H04L 12/58

(52) U.S. Cl. CPC H04L 51/00
USPC 709/206

(57) ABSTRACT

A system for sending invitations potential subscribers of a service provider includes a registration engine configured to complete a registration process with a registering user. Furthermore, the registration engine is further configured during the registration process to receive from the registering user: a) an e-mail address of the registering user; b) access information for that e-mail address; c) permission to access the e-mail address; and d) an instruction to send an invitation to join the service provider to at least some of a plurality of addresses within an address book of the registering user. The system also includes an authorization engine configured to extract the plurality of addresses from the address book; and an invitation engine configured to send a respective invitation to at least one of the extracted plurality of addresses.

### RELATED APPLICATIONS INFORMATION

This present application claims the benefit of priority as a Continuation under 35 U.S.C. §120 of U.S. patent application Ser. No. 13/444,795, filed Apr. 11, 2012, entitled “Automated user-initiated invitation system and method,” which in turn claims the benefit of priority as a Continuation under 35 U.S.C. §120 of U.S. patent application Ser. No. 11/329,524, filed Jan. 10, 2006, entitled “Automated user-initiated invitation system and method,” which in turn claims the benefit of priority under 35 U.S.C. §119(e) of US. Provisional Application 60/643,372, filed Jan. 11, 2005, entitled “Method and system by which automated invitations are sent,” all of which are incorporated herein by reference in their entirety as if set forth in full.

### FIELD OF THE INVENTION

The present invention relates to an automated distribution and billing platform for networked applications, and, more particularly, relates to allowing users of the platform to forward invitations other users.

### BACKGROUND

The ubiquity of the Internet, e-mail access, and cellular telephones have created an environment in which users can be in communications with friends and family at nearly all times. Accordingly, a number of services and service providers have arose that provide users with virtual communities in which people are allocated virtual spaces which they can personalize and customize. Within such communities of personal spaces, users having similar interests or some other connection or bond can congregate and socialize or share information and other news.

Because users rely on such virtual communities to socialize and communicate with other people, the usefulness and desirability of such communities is enhanced when as many of a user's friends and family as possible are part of the virtual community. Thus, there is a need for a user of a virtual community and other, similar services to be able to invite and facilitate the registration of their friends and families into the virtual community.

### SUMMARY

One aspect of the present invention relates to a method for allowing a user of a service to send invitations to join the service. In accordance with this method, an instruction is received from a user authorizing access to an address book of the user. Then one or more addresses are extracted from the address book; and an invitation to join the service is sent to at least one of the one or more addresses from the address book.

Another aspect of the present invention relates to a system for sending invitations to potential subscribers of a service provider. This system includes a registration engine configured to complete a registration process with a registering user. Furthermore, the registration engine is further configured to receive from the registering user: a) an e-mail address of the registering user; b) access information for that e-mail address; c) permission to access the e-mail address; and d) an instruction to send an invitation to join the service provider to at least some of a plurality of addresses within an address book of the registering user. The system also includes an authorization engine configured to extract the plurality of addresses from the address book; and an invitation engine configured to send a respective invitation to at least one of the extracted plurality of addresses.

Yet another aspect of the present invention relates to a method for augmenting a contact list for a service provider. In accordance with this method, a registration process is initiated with the user and during the registration process, permission is requested to send a respective invitation to one or more addresses within an address book of the user. Next, one or more addresses are extracted from the address book of the user and the one or more addresses are added to a service provider contact list. Finally, an invitation to join the service provider is sent to at least one of the one or more addresses.

It is understood that other embodiments of the present invention will become readily apparent to those skilled in the art from the following detailed description, wherein is shown and described only various embodiments of the invention by way of illustration. As will be realized, the invention is capable of other and different embodiments and its several details are capable of modification in various other respects, all without departing from the spirit and scope of the present invention. Accordingly, the drawings and detailed description are to be regarded as illustrative in nature and not as restrictive

### BRIEF DESCRIPTION OF THE DRAWINGS

FIG. 1 depicts a block diagram of a computer platform on which embodiment of the present invention may be implemented.

FIG. 2 depicts a block diagram of a computer-based virtual community.

FIG. 3 depicts a flowchart of an exemplary method for allowing users to invite other members into the community in accordance with the principles of the present invention.

FIG. 4 depicts a functional block diagram of a computer platform for performing the exemplary method of FIG. 3.

FIG. 5 depicts a flowchart of an exemplary method of allowing already registered users to send invitations to members of their address book

### DETAILED DESCRIPTION

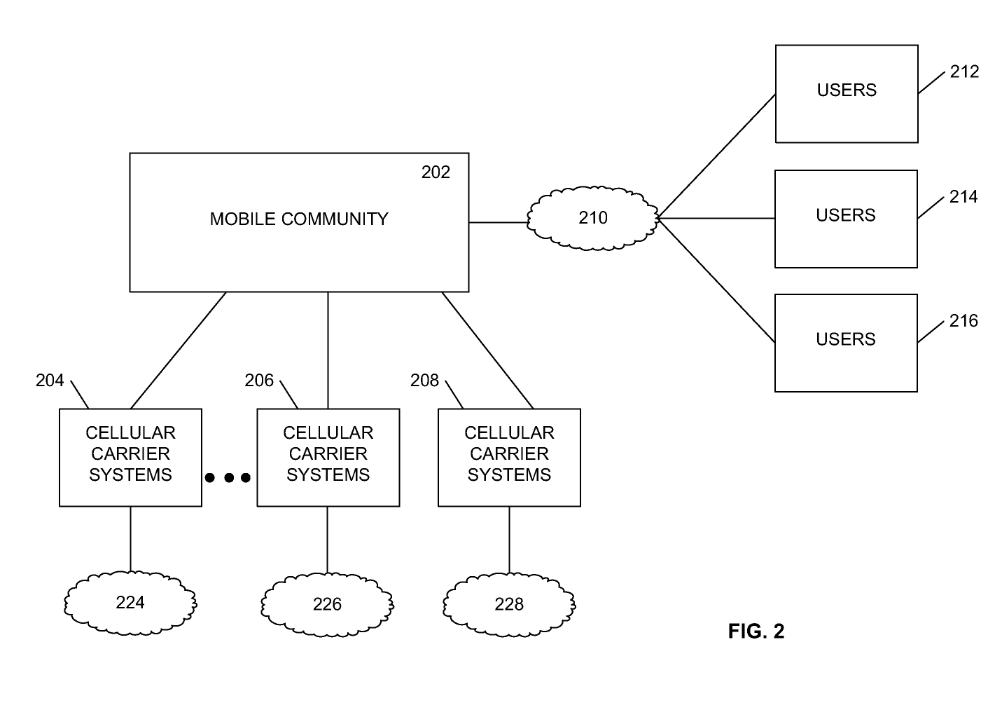

FIG. 2 depicts a block diagram of a computer-based virtual mobile community 202. Only a brief summary of the details of the mobile community 202 is provided below. The full details of this community and system are described in U.S. Patent Application Ser. No. 60/714,978, filed on Sep. 7, 2005, the disclosure of which is incorporated herein in its entirety. Users 212, 214, 216 can connect to the mobile community 202 via a network or similar communications channel 210. Via the connection, a user (e.g., 212) may create a profile page or “home page” that they can personalize. This profile page can include various files and content that the user wants to share with other members of the mobile community 202.

The profile page may include a hierarchy of pages, some of which are for public view and some of which have restrictions on viewing. For example, the mobile community 202 can be logically organized into neighborhoods such as “friends”, “family”, “workplace”, “dog owners”, etc. Users 212, 214, 216 can belong to these different neighborhoods and share different pages with the members of the different neighborhoods.

Additionally, this mobile community connects with various cellular carrier systems 204, 206, 208, each of which has an associated community of mobile phone subscribers, 224, 226 and 228. Users 212, 214, 216 of the mobile community 202 are also subscribers of various cellular carriers. In this way, users 212, 214, 216 of the mobile community 202 not only have access through the computer-based platform 202 to other users' profile pages, they also have easy access to subscribers of the various cellular carrier systems 204, 206, 208.

A benefit of the architecture depicted in FIG. 2, is that the mobile community platform 202 has already contracted for services with the cellular carrier systems 204, 206, 208. As is known in the art, the cellular carrier systems 204, 206, 208 provide messaging and premium message functionality. Such messages are sent via the cellular carrier's infrastructure to mobile subscribers and, internal to the cellular carrier's infrastructure, generates a billing event according to a particular tariff rate. In practice, when the mobile community 202 sends a message via a cellular carrier system (e.g., 204), it is billing the recipient of the message using the existing billing system of that cellular carrier. The billing event is often a micro-transaction. Thus, a user (e.g., 212) of the mobile community may conduct transactions with a vendor within the mobile community 202 and be billed for those transactions via their cellular service account. The vendor in the transaction need only communicate with the mobile community 202 regarding the transaction and does not require any affiliation or agreement with any cellular carrier.

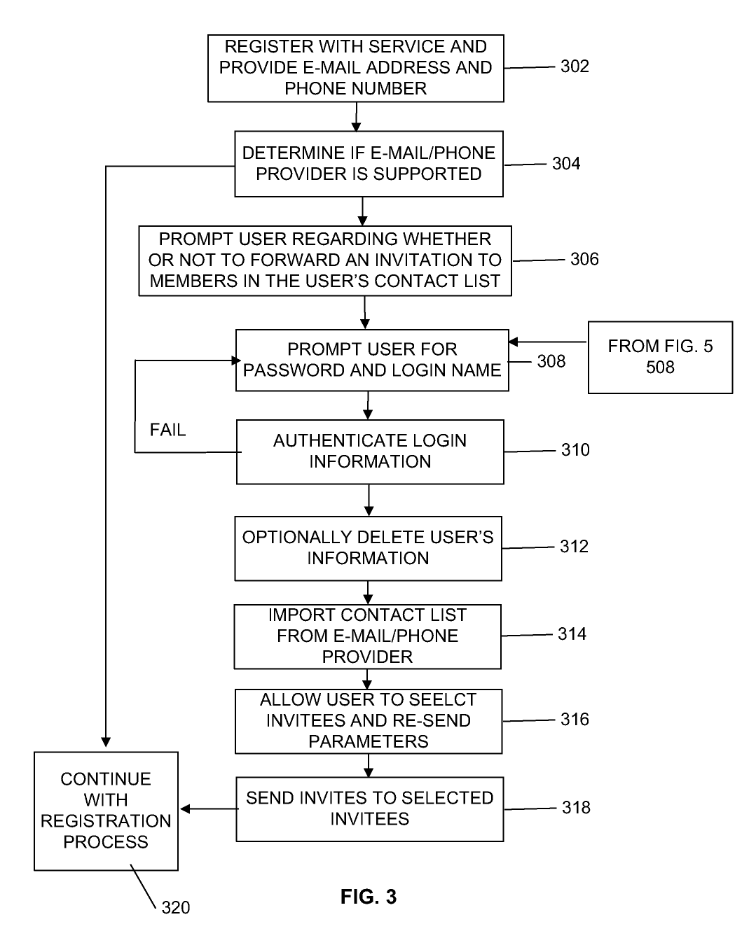

The experience of the user (e.g., 212) within the mobile community 202 will be more enjoyable then there are more members of the mobile community 202 with which the user (e.g., 212) would like to communicate. Accordingly, embodiments of the present invention provide techniques that help ensure that people already familiar to the user (e.g., 212) are invited to become members of the mobile community 212. FIG. 3 depicts a flowchart of an exemplary method that operates in accordance with the principles of the present invention. The steps of the flowchart of FIG. 3 are described below within the context of a specific example involving the mobile community of FIG. 2. However, there is no requirement that the steps be used in this specific environment but, instead, can be used by other types of service providers to assist a user in inviting other members to join a particular service.

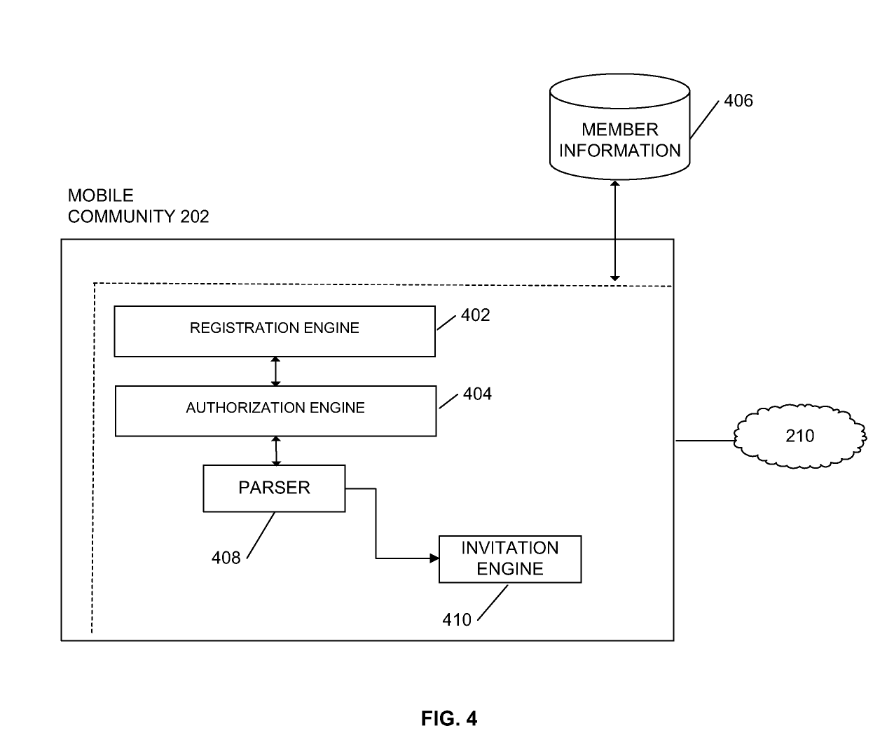

When a new user arrives at the mobile community 202, a registration screen is presented to the user that prompts the user to enter a variety of identifying information. For example, in step 302, the registration process results in the user providing an e-mail address and a mobile telephone number to the mobile community 202. To aid in the understanding of the flowchart of FIG. 3, FIG. 4 is provided with a more detailed view of those aspects of the mobile community 202 that are directly relevant to understanding the flowchart of FIG. 3.

In particular, the registration engine 402 is a software component of the community 202 that handles the presentation of screens to new users during the registration process and also receives replies and responses from the registering users. Once the e-mail address is received, the registration engine 402 determines, in step 304, whether the e-mail address is from a supported domain. For example, “hotmail.com” or “yahoo.mail” are two e-mail domains that may be supported. Other supported domains include, but are not limited to: 163.com, adelphia.net, AOL, bellsouth.net, BOL.com, btinternet.com, cantv.net, caramail.com, clubinternet.fr, comcast.net, cox.net, cs.com, docomo.ne.jp, earthlink.net, email.com, excite.com, free.fr, freenet.de, gmail.com, gmx.de, gmx.net, hanmail.net, hetnet.nl, home.nl, Hotmail, Hotmail country domains (UK, France, Germany and Italy), ibest.com.br, ig.com.br, indiatimes.com, juno.com, latinmail.com, libero.it, lycos.com, mail.com, mail.ru, MSN, mynet.com, naver.com, netscape.net, netzero.net, ntlworld.com, pacific.netsg, pandora.be, planet.nl, pop.com.br, prodigy.net.mx, Rediff.com, rogers.com, sbcglobal.net, shaw.ca, Sina.com, singnet.com.sg, skynet.be, Sohu.com, sympatico.ca, terra.com.br, terra.es, tiscali.co.uk, tiscali.fr, tiscali.it, tiscalinet.it, Tom.com, t-online.de, uol.com.br, usa.net, verizon.net, voila.fr, wanadoo.fr, wanadoo.nl, web.de, xtra.co.nz, Yahoo, Yahoo country domains (China, Brazil, France, Canada, UK, India, Singapore and Malaysia), zipmail.com.br.

If the e-mail domain is supported, then the registering user is presented with an invitation screen, in step 306, that informs the user that if they desire, they can send an e-mail message to all members of their contact list that invites those members to join the mobile community 202. The invitation screen also prompts the user, in step 308, to enter their login information for the e-mail address (e.g., username and password). The user is informed that if they would like to send invitations, then they should fill out the login information. If, however, they do not want to send invitations, then they can leave the login information blank. Thus, the sending of invitations to the members of the contact list is completely at the discretion of the registering user and only takes place if the registering user so decides. Once, the user decides on a course of action, then a “Finish”, “Next”, or “Submit” button is selected to continue.

In step 310, the authorization engine 404 uses the provided login information to authenticate with the e-mail provider. This may entail simply logging into the e-mail provider's access area like a typical user or it may entail other techniques. For example, the e-mail provider may permit a variety of different authentication methods such that completing authentication of any one of them allows access into the e-mail system. One specific example would be a e-mail provider that provides not only e-mail service but also instant-messaging service. Thus, authenticating for either one of the services would allow access into the e-mail area. If authentication fails, then the user can be prompted to re-enter the login information in case a mistake was made and then authentication is retried. If a second failure occurs, then the authorization engine 404 returns control to the registration engine who continues with the registration process in step 320.

Once authentication is successfully completed, the authorization engine 404 has access to the user's e-mail account and its content. At this time, the authorization engine 404 may delete the user's information so that a persistent copy of the username and password are not stored within the mobile community 202. This deletion is, however, an optional step. For example, retaining this information may be useful for other services such as periodically checking that e-mail account and forwarding messages from there to other e-mail accounts.

Once the authorization engine 404 has access to the e-mail account of the user, then the authorization engine can retrieve the address book, or contact list, from the e-mail provider, in step 314. The specific manner in which a username and password are used to login into an e-mail provider and extract an address book depends on the specific implementation of the e-mail provider's system. One of ordinary skill will recognize that many functionally equivalent techniques may be used, as well, without departing from the scope of the present invention. Furthermore, if the e-mail provider and the mobile community explicitly partner for the purposes of facilitating this extraction of contact lists, then the e-mail provider may develop and publish a specific API for the mobile community system to use to easily extract the contact list.

Part of the process for importing a contact list or address book includes parsing the HTML to extract just the e-mail addresses. The other extraneous characters and information need to be ignored so that the e-mail addresses within the contact list can be retrieved. The parser 408 is responsible for receiving the raw HTML from the authorization engine 404 and extracting just the e-mail addresses that are then forwarded to the invitation engine 410.

Once the addresses from the address book or contact list are forwarded to the invitation engine 410, the engine 410 can automatically send out a default invitation letter to all the people on the list inviting them, on behalf of the registering user, to join the mobile community 202. However, additional customization and selectivity at this point is advantageous. In particular, the invitation engine 410 can generate a screen that is presented to the user informing them of the addresses that were extracted from the address book or contact list. The registering user can then select or de-select certain addresses so that only a limited number of the addresses receive the invitation. Furthermore, the text of the invitation message can be presented in an editable window so that the registering user can customize and personalize the invitation letter.

Another available option includes the ability to re-send the invitation periodically. For example, if an invitee does not respond at all to the initial invitation, then a subsequent invitation can be re-sent. The registering user can select how often to re-send the invitation. For example, the registering user can elect to send no “re-sends”, can elect to periodically send one every x months for a period of y months (where x and y are appropriate integer values that the user can specify). Thus, in step 316, the registering user can customize the invitation process by selecting on certain e-mail address to receive an invitation and also personalizing the actual invitation as well as the re-send parameters.

In step 318, the invitation engine 410 sends the invitations according to the parameters selected in step 318. The e-mail addresses along with the re-send meta-data for each address is stored in the database 406. Thus, periodically, the invitation engine 410 reviews the information in the database 406 and determines when a re-send invitation is scheduled. Once the invitations are sent, then the registration engine 402 continues with the registration process in step 320. If desired, the actual sending of the invitations, in step 318, can be delayed until the registering user fully completes the registration process.

There are a number of optional features that can be included within the flowchart of FIG. 3 to increase the efficiency and user-friendliness of the invitation process. For example, as part of the authentication process of step 310, the authorization server can determine if this e-mail address has previously been used to find and extract an address book. If so, then the authorization engine can inform the user that invitations were recently sent to members of the address book and that additional invitations will not be re-sent. The determination whether or not to send invitations to members of the address book can be based on how recently (e.g., within the last n hours) the address book was extracted.

Another option is to avoid sending invitations to addresses that were already imported from someone else's address book. Thus, when the registering user is presented with the list of potential invitees in step 316, no e-mail addresses will be presented that have already been stored in the database 406 from previously extracted phone books. However, when an invitation is re-sent at some later time, the re-sent invitation includes the names of all registering members (not just the first) that is issuing the invitation. Thus, the recipient of the re-sent invitation knows on whose behalf the invitation was sent.

In some instances, some of the extracted e-mail addresses will correspond to individuals who are already members of the mobile community 202. In these instances, there is no need to send an invitation to these addresses. It may be advantageous, however, to inform the registering member of the identity of these current members so that the registering member knows to look for these current members within the mobile community 202. This can be done by displaying a picture of the current members along with their name and other contact information. Alternatively, the current member can specify what graphic image or other data to display in such an instance.

In the previous examples, the specific address books and contact lists described were related to e-mail addresses. However, many mobile phones also include contact lists that have phone numbers and e-mail addresses. Thus, in addition to asking the registering user whether or not they want to send invitations to the people in their e-mail address books, they can be asked whether or not they want invitations sent to addresses in their mobile phone. To get access to the mobile device's address book, the device's user typically has to initiate the transfer of the address book to a third party. Thus, instead of authenticating to an e-mail server and downloading an address book, the authorization engine would send a text message to the registering user's mobile device asking them to respond by initiating a transfer of the address book. Once the authorization engine 402 has the address book, the parser can extract the addresses as before.

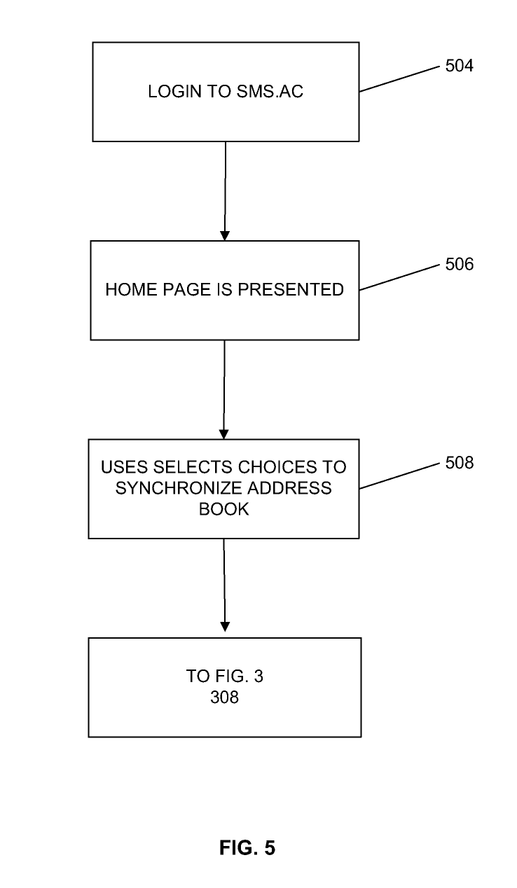

Furthermore, in the above examples, the synchronization of address books has been described as part of the registration process with the service provider. The flowchart of FIG. 5, in contrast, depicts an exemplary method which allows already registered user to send invitations to addresses in their address book. Such functionality may be advantageous if the user bypassed the synchronization process when they originally registered with the service provider. In accordance with this method, the user logs into their account with the service provider (e.g., sms.ac) in step 504. once the user is logged in then they are presented with their home page in step 506.

From their home page, the user can traverse the available selections and links, in step 508, to arrive at a screen that allows them to make a selection to synchronize their address book. Once this choice is made, then the process described in FIG. 3 is performed starting at step 308. One difference is that when the process completes, the user is returned to their home page rather than continuing with the registration process at step 320.

Although not mentioned earlier, yet applicable to both applications, the user may provide more than one supported e-mail address having an associated address book. In this case, the system will authenticate multiple e-mail addresses and passwords and import multiple address books. The addresses from all the address books will be combined into a single invitation list.

The re-sending of invitations may be handled as a manual process as well. Because the user originally went through the synchronization process during the original registration process, the addresses from their e-mail address book are also in their current address book within the mobile community. Thus, when the user visits their address book (or possibly some other page) they may be given the option to re-send invitations to those individuals that they realize did not respond to the first invitation to join the community. In operation, a list of all members in their address book can be displayed so that the user can select some, de-select some, select “all”, thereby identifying those addresses to which invitations should be re-sent. This feature supplements the original sending of invitations and requested re-sends which the user requested at the time of registration. Because the mobile community retains information regarding previous invitations, it may choose to omit displaying addresses that relate to current members or addresses who have asked not to receive additional invitations. Thus, the user may not be given the choice to re-send invitations to such addresses.

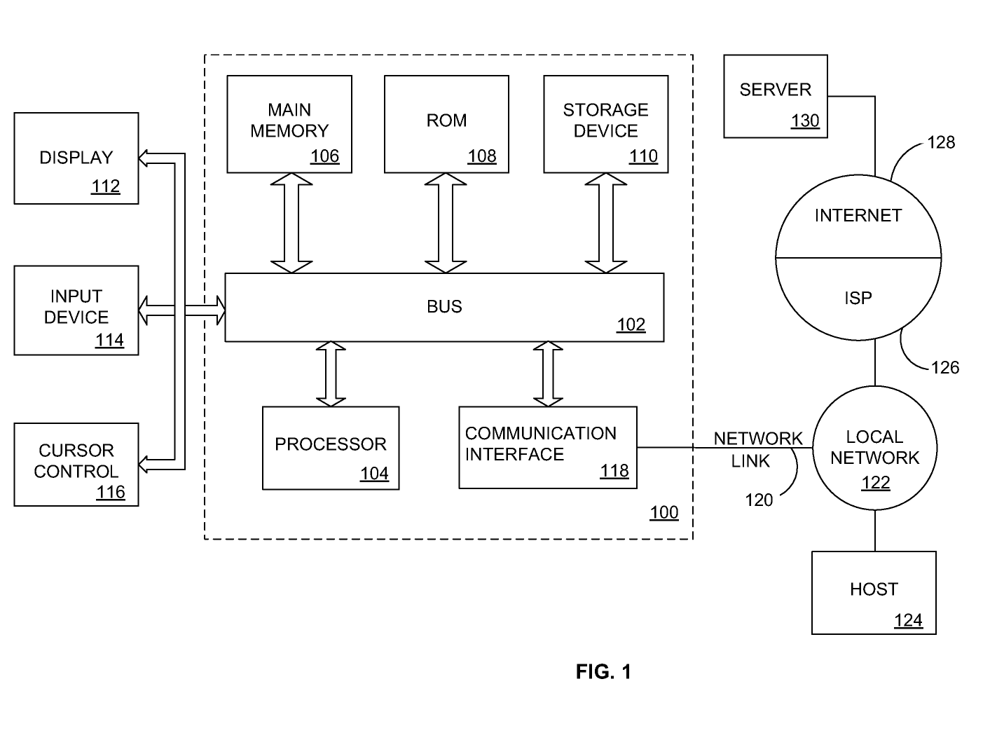

At least portions of the invention are intended to be implemented on or over a network such as the Internet. An example of such a network is described in FIG. 1. The description of the network and computer-based platforms that follows is exemplary. However, it should be clearly understood that the present invention may be practiced without the specific details described herein. Well known structures and devices are shown in block diagram form in order to avoid unnecessarily obscuring the present invention.

FIG. 1 is a block diagram that illustrates a computer system 100 upon which an embodiment of the invention may be implemented. Computer system 100 includes a bus 102 or other communication mechanism for communicating information, and a processor 104 coupled with bus 102 for processing information. Computer system 100 also includes a main memory 106, such as a random access memory (RAM) or other dynamic storage device, coupled to bus 102 for storing information and instructions to be executed by processor 104. Main memory 106 also may be used for storing temporary variables or other intermediate information during execution of instructions to be executed by processor 104. Computer system 100 further includes a read only memory (ROM) 108 or other static storage device coupled to bus 102 for storing static information and instructions for processor 104. A storage device 110, such as a magnetic disk or optical disk, is provided and coupled to bus 102 for storing information and instructions.

Computer system 100 may be coupled via bus 102 to a display 112, such as a cathode ray tube (CRT), for displaying information to a computer user. An input device 114, including alphanumeric and other keys, is coupled to bus 102 for communicating information and command selections to processor 104. Another type of user input device is cursor control 116, such as a mouse, a trackball, or cursor direction keys for communicating direction information and command selections to processor 104 and for controlling cursor movement on display 112. This input device typically has two degrees of freedom in two axes, a first axis (e.g., x) and a second axis (e.g., y), that allows the device to specify positions in a plane.

Computer system 100 operates in response to processor 104 executing one or more sequences of one or more instructions contained in main memory 106. Such instructions may be read into main memory 106 from another computer-readable medium, such as storage device 110. Execution of the sequences of instructions contained in main memory 106 causes processor 104 to perform the process steps described herein. In alternative embodiments, hard-wired circuitry may be used in place of or in combination with software instructions to implement the invention. Thus, embodiments of the invention are not limited to any specific combination of hardware circuitry and software.

The term “computer-readable medium” as used herein refers to any medium that participates in providing instructions to processor 104 for execution. Such a medium may take many forms, including but not limited to, non-volatile media, volatile media, and transmission media. Non-volatile media includes, for example, optical or magnetic disks, such as storage device 110. Volatile media includes dynamic memory, such as main memory 106. Transmission media includes coaxial cables, copper wire and fiber optics, including the wires that comprise bus 102. Transmission media can also take the form of acoustic or light waves, such as those generated during radio-wave and infra-red data communications.

Common forms of computer-readable media include, for example, a floppy disk, a flexible disk, hard disk, magnetic tape, or any other magnetic medium, a CD-ROM, any other optical medium, punchcards, papertape, any other physical medium with patterns of holes, a RAM, a PROM, and EPROM, a FLASH-EPROM, any other memory chip or cartridge, a carrier wave as described hereinafter, or any other medium from which a computer can read.

Various forms of computer readable media may be involved in carrying one or more sequences of one or more instructions to processor 104 for execution. For example, the instructions may initially be carried on a magnetic disk of a remote computer. The remote computer can load the instructions into its dynamic memory and send the instructions over a telephone line using a modem. A modem local to computer system 100 can receive the data on the telephone line and use an infra-red transmitter to convert the data to an infra-red signal. An infra-red detector can receive the data carried in the infra-red signal and appropriate circuitry can place the data on bus 102. Bus 102 carries the data to main memory 106, from which processor 104 retrieves and executes the instructions. The instructions received by main memory 106 may optionally be stored on storage device 110 either before or after execution by processor 104.

Computer system 100 also includes a communication interface 118 coupled to bus 102. Communication interface 118 provides a two-way data communication coupling to a network link 120 that is connected to a local network 122. For example, communication interface 118 may be an integrated services digital network (ISDN) card or a modem to provide a data communication connection to a corresponding type of telephone line. As another example, communication interface 118 may be a local area network (LAN) card to provide a data communication connection to a compatible LAN. Wireless links may also be implemented. In any such implementation, communication interface 118 sends and receives electrical, electromagnetic or optical signals that carry digital data streams representing various types of information.

Network link 120 typically provides data communication through one or more networks to other data devices. For example, network link 120 may provide a connection through local network 122 to a host computer 124 or to data equipment operated by an Internet Service Provider (ISP) 126. ISP 126 in turn provides data communication services through the world wide packet data communication network now commonly referred to as the “Internet” 128. Local network 122 and Internet 128 both use electrical, electromagnetic or optical signals that carry digital data streams. The signals through the various networks and the signals on network link 120 and through communication interface 118, which carry the digital data to and from computer system 100, are exemplary forms of carrier waves transporting the information.

Computer system 100 can send messages and receive data, including program code, through the network(s), network link 120 and communication interface 118. In the Internet example, a server 130 might transmit a requested code for an application program through Internet 128, ISP 126, local network 122 and communication interface 118. The received code may be executed by processor 104 as it is received, and/or stored in storage device 110, or other non-volatile storage for later execution. In this manner, computer system 100 may obtain application code in the form of a carrier wave.

The previous description is provided to enable any person skilled in the art to practice the various embodiments described herein. Various modifications to these embodiments will be readily apparent to those skilled in the art, and generic principles defined herein may be applied to other embodiments. Thus, the claims are not intended to be limited to the embodiments shown and described herein, but are to be accorded the full scope consistent with the language of the claims, wherein reference to an element in the singular is not intended to mean “one and only one” unless specifically stated, but rather “one or more”. All structural and functional equivalents to the elements of the various embodiments described throughout this disclosure that are known or later come to be known to those of ordinary skill in the art are expressly incorporated herein by reference and intended to be encompassed by the claims. Moreover, nothing disclosed herein is intended to be dedicated to the public regardless of whether such disclosure is explicitly recited in the claims.

What is claimed is:

1. In a mobile community platform comprising a computer system including at least one processor and a registration engine, an authorization engine, and an invitation engine executed by the at least one processor, a method for allowing a user of a service offered by a service provider to send invitations to join the service, comprising:
in the registration engine, by the computer system, requesting permission to access a user's address book;
in the registration engine, by the computer system, receiving from the user an instruction authorizing the registration engine to access the address book of the user in response to the request, the address book stored on a server that is separate from the platform, the instruction including account information;
in the authorization engine, by the computer system,
accessing the server,
submitting the account information to the server for authentication,
extracting one or more addresses from the address book once the platform is authenticated, and
adding the one or more addresses to a service provider contact list associated with the service provider; and
in the invitation engine, by the computer system, sending an invitation to join the service to at least one of the one or more addresses from the address book via the server.

2. The method of claim 1, wherein each of the one or more addresses comprises an e-mail address.

3. The method of claim 1, wherein the account information includes an e-mail address of the user.

4. The method of claim 3, further comprising, in the registration engine, determining if the e-mail address of the user is associated with a predetermined e-mail service provider.

5. The method of claim 1, wherein the account information is associated with an e-mail service provider.

6. The method of claim 5, wherein the account information includes a username and a password.

7. The method of claim 1, wherein the address book comprises HTML code.

8. The method of claim 7, wherein the mobile community platform further comprises a parser, and wherein the method further comprises, in the parser, parsing the HTML code to extract the one or more addresses.

9. The method of claim 1, further comprising, in the invitation engine, prompting the user to selected a subset of the extracted addresses to which to send invitations, and receiving input from the user related to the subset.

10. The method of claim 1, further comprising, in the authorization engine, determining if the at least one of the one or more addresses has already been sent a previous invitation; and if so, avoiding sending another invitation to the at least one of the one or more addresses.

11. The method of claim 1, further comprising, in the invitation engine, determining which of the at least one of the one or more addresses were non-responsive to their respective invitation; and re-sending a subsequent invitation to each of the non-responsive addresses.

12. A mobile community platform for sending invitations to potential subscribers of a service provider, the mobile community platform comprising:
at least one processor;
a registration engine, configured, when executed by the at least one processor, to complete a registration process with a registering user, the registration process causing the registration engine to
send a request to the user to access an address book associated with the user and stored on a separate server,
receive from the user permission to access the address book,
receive from the user account information for accessing the address book, and
receive from the user an instruction to send an invitation to join a service offered by the service provider to at least one of one or more addresses within the address book;
an authorization engine configured, when executed by the at least one processor, to
cause the mobile community platform to access the separate server on which the address book of the user is stored,
authenticate the platform with the separate server using the account information, and
extract the one or more addresses from the address book; and
an invitation engine configured, when executed by the at least one processor, to send an invitation to at least one of the extracted addresses based on the instruction received from the user.

13. The mobile community platform of claim 12, wherein each of the one or more addresses comprises an e-mail address.

14. The mobile community platform of claim 12, wherein the account information comprises an e-mail address of the user.

15. The mobile community platform of claim 14, further comprising, in the registration engine, determining if the e-mail address of the user is associated with a predetermined e-mail service provider.

16. The mobile community platform of claim 12, wherein the account information is associated with an e-mail provider.

17. The mobile community platform of claim 16, wherein the account information includes a username and a password.

18. The mobile community platform of claim 12, wherein the address book comprises HTML code.

19. The mobile community platform of claim 18, wherein the mobile community platform further comprises a parser, and wherein the method further comprises, in the parser, parsing the HTML code to extract the one or more addresses.

20. The mobile community platform of claim 12, further comprising, in the invitation engine, prompting the user to selected a subset of the extracted addresses to which to send invitations, and receiving input from the user related to the subset.

21. The mobile community platform of claim 12, further comprising, in the authorization engine, determining if the at least one of the one or more addresses has already been sent a previous invitation; and if so, avoiding sending another invitation to the at least one of the one or more addresses.

22. The mobile community platform of claim 12, further comprising, in the invitation engine, determining which of the at least one of the one or more addresses were non-responsive to their respective invitation; and re-sending a subsequent invitation to each of the non-responsive addresses.
